(19) United States
(12) Patent Application Publication
(10) Pub. No.: US 2022/0338960 A1
(43) Pub. Date: Oct. 27, 2022

(54) ORTHODONTIC APPLIANCE AND METHOD OF FORMING AND APPLYING SAME

(71) Applicant: Brian C. Reising, Johns Creek, GA (US)

(72) Inventor: Brian C. Reising, Johns Creek, GA (US)

(21) Appl. No.: 17/660,791

(22) Filed: Apr. 26, 2022

Related U.S. Application Data
(60) Provisional application No. 63/179,758, filed on Apr. 26, 2021.

(51) Int. Cl. A61C 7/14; A61C 7/16; A61C 7/00

(52) U.S. Cl. CPC A61C 7/145; A61C 7/146; A61C 7/16; A61C 7/002

(57) ABSTRACT

An orthodontic appliance includes an indirect bonding tray; at least one bracket segment integrally formed with the indirect boding tray; an integral slot location feature formed in the at least one bracket segment; a support structure configured to be bonded with the at least one bracket segment and wherein the integral slot location feature is configured to positively orient the support structure relative to the at least one bracket segment, the support structure being further configured to retain an arch-wire; and wherein a weakened section joins the indirect bonding tray and the at least one bracket segment, the weakened section being configured to facilitate removal of the indirect bonding tray from the at least bracket segment after installation of the at least one bracket segment. An associated method of creating and installing the orthodontic appliance is also disclosed.

### CROSS REFERENCE TO RELATED APPLICATIONS

This application claims priority to U.S. Provisional Patent Application No. 63/179,758 filed Apr. 26, 2021, which is hereby incorporated by reference herein in its entirety.

### TECHNICAL FIELD

The present disclosure relates generally to dentistry and orthodontics and, in particular, to attaching orthodontic brackets to teeth for repositioning the teeth.

### BACKGROUND

Orthodontists commonly correct the position of mal-occluded and mal-aligned teeth by therapeutic tooth movement. Therapeutic tooth movement is accomplished by the application of force to teeth to reposition them. Many orthodontic appliances have been used to apply force to teeth. The most commonly used orthodontic appliance for tooth movement is commonly known as the “edgewise appliance” or more specifically the “fixed pre-adjusted edgewise appliance”—also known as the “straight-wire appliance.” The name “edgewise” refers to the general mechanism of a rectangular slot engaged by a force-generating rectangular wire. The terms “straight-wire”, “pre-adjusted”, and “pre-programmed” refer to an elective, though highly desirable, feature of an edgewise appliance system that will be described as follows.

An edgewise appliance system is a combination of many individual pieces designed to function in a coordinated fashion. The two primary components are tooth “attachments” that are attached to the teeth and “arch-wires” that engage the attachments. The attachments (brackets or bands) are semi-permanently and rigidly attached to the teeth. Typically, the attachments are fabricated of stainless steel, porcelain (ceramic), plastic, or combinations of these materials. The attachments serve as a standardized “handle” by which the tooth may be engaged by a force.

Each attachment in a system (generally referred to as a “bracket”) possesses a rectangular slot that receives the arch-wire component. Typically, all the attachments of a particular system will have the same rectangular slot dimensions of about 0.018×0.025 inches, 0.020×0.025 inches or 0.022×0.025 inches. Some operators prefer to use a combination of various size slots. The slot shape is rectangular to accommodate a wire with a rectangular or square cross section, which permits application of forces and hence control of tooth position in three dimensions.

Typically, arch-wires are made of metal alloys capable of varying degrees of elastic deflections depending on their size, cross-sectional shape, and composition. The elastic deflections in the arch-wire generate forces on the brackets, which in turn translate the forces to the teeth, thereby causing the teeth to move to a desired position.

The human teeth are arranged spatially in the upper or lower jaw (the maxillary or mandibular dental arches respectively) in the shape of an arch with their long axes generally perpendicular to the plane of the arch. The precise shape of the arch varies among individuals from more U-shaped arches to V-shaped arches to parabolic arch forms. The precise shape of any particular arch can vary substantially.

Given that the teeth are naturally arranged in this relatively flat-plane arch-form, it is commonly recognized as an objective of orthodontic therapy that this plane should be made relatively flat and that the teeth should be aligned precisely to form an arch-form shape that is similar (but improved) to the pre-existing condition of the dentition. To serve this objective, the “straight-wire”, “pre-adjusted”, or “pre-programmed” concept of appliance design was derived as a means of executing orthodontic therapy with greater ease, efficiency, and quality. The basic concept of “straight-wire” is that, if the objective of orthodontic therapy is to position teeth in a flat plane, then the force generated by elastic deformations in a flat, straight wire shaped in the form of an arch is an ideal mechanism for producing those results. In theory, the attachments are rigidly fixed to teeth at a precise “pre-adjusted” or “pre-programmed” position on the mid-facial or lingual aspect of a tooth at their respective mal-aligned state. A straight (flat) arch-shaped wire is then deflected to engage the mal-aligned attachments slots. The force generated by the elastic deformation of the wire then “pulls” the teeth along with it as it moves back towards its original shape. The attachment position on each tooth then determines the ultimate and final relative position of each tooth relative to the other teeth upon achievement of the “straight-wire” condition (the theoretical endpoint).

Traditionally, the vast majority of orthodontic therapy has been performed with attachment slots placed primarily on the facial aspect of the teeth. It can be readily deduced via casual observation of an arch of teeth that the mid-facial aspects of an arch of teeth tend to align in a straight, flat arch form. However, it is also readily observed upon closer inspection that these mid-facial surfaces do not exactly line up in a straight line with their long axes residing at identical orientations. In fact, one can readily observed consistent deviations in the spatial relations of an arch of tooth crowns and roots. Each tooth type tends to deviate in a specific consistent “average” way relative to the horizontal plane. As such, early pioneers of appliance design theorized that compensations in bracket slot orientation relative to the bracket segment could automatically compensate for these differences.

They also realized that the anatomy among types of teeth (upper right central incisor, versus, for instance, an upper right canine, etc.) varies substantially. But because this anatomy is consistent among different individuals for each tooth type, each tooth type, therefore, could receive its own uniquely shaped “average” bracket slot and base orientation. This pre-defined shape can theoretically be used on a particular tooth type for any particular individual. Thus, while the general shape of a bracket system might be very similar, for each particular tooth type the corresponding bracket is designed with specific compensations in base shape, base size, general shape, slot angulation, base thickness, etc. to accommodate differences in tooth type anatomy and tooth type spatial relations relative to the horizontal plane.

The intention of these design specifications was to create a universally applicable appliance that will, if brackets positions are accurately coordinated, create an ideal alignment of teeth if a straight wire is deflected into each slot and if the wire is subsequently permitted to express its original straight shape. By doing so, the operator would possess a pre-programmed mechanical system. Having realized a truly pre-programmed system, theoretically, the operator could eliminate the need for manual manipulation of the system (via the placement of compensating bends in the arch-wire component) and thus produce a highly predictable and efficient outcome.

However, as mentioned, the efficient utilization of a so-called straight-wire appliance depends largely on the orthodontist's ability to coordinate the position of the brackets on mal-aligned teeth so that the forces imposed by deflections of the resilient, straight, arch-wire will result in perfect three-dimensional alignment of the teeth. If the brackets are not properly positioned, then the degree of mal-positioning will be reflected as a proportional degree of mal-positioning of the teeth. Correcting these mal-positions would then require the operator to manually manipulate the shape of the arch-wire component via the placement of compensating arch-wire bends. This is recognized as a comparatively laborious, slow, unpredictable, and inefficient method.

Most orthodontists position the brackets on the patient's teeth using a “direct” method. “Direct” refers to the positioning of each bracket on each tooth directly, inside the patient's mouth. But when working directly inside the mouth it is very difficult to visualize precise bracket positioning and extremely cumbersome to utilize measuring instruments for determining vertical position. Because accurate positioning is so difficult, getting the bracket “close enough” is widely regarded as an acceptable compromise. Because precise positioning of an entire arch of brackets is the exception rather than the norm, the result is a huge compromise in treatment quality and efficiency.

To improve the accuracy of bracket positioning in a typical private practice setting, “indirect” positioning methods have been developed. Rather than positioning brackets directly inside the patient's mouth, the brackets are positioned on a three-dimensional model of the patient's teeth, outside the patient's mouth. In this way, improved visualization and the utilization of measuring devices are permitted, so accurate positioning becomes much more simple and attainable. Once the brackets are positioned on the model and rigidly attached, a “transfer tray” is fabricated and utilized to transfer the brackets from the model to the patient's mouth. The tray preserves the brackets position during the transfer. There are a number of known variations of indirect methods, including those described in U.S. Pat. No. 5,971,754 to Sondhi et al. and U.S. Pat. No. 4,952,142 to Nicholson, which are hereby incorporated herein by reference.

There are drawbacks to conventional bracket systems, regardless of the attachment method used. Typical brackets (both facial and lingual types) are composed of two basic structures. The first, a broad, flat base. Second, is a structure(s) protruding perpendicular to the base that forms the “open face” rectangular slot and the “tie-wings” that are used to anchor a disposable ligature that, in turn, maintains engagement of the wire component in the slot.

Generally, with a facial or lingual bracket system, all anterior and premolar brackets are designed with an open-face slot that allows the arch-wire component to be inserted into the slot along a facio-lingual vector. This bracket design requires the presence of tie-wings to engage and maintain engagement of the wire component. Because of the necessity of tie-wings, these brackets must possess a certain degree of structural profile height and shape irregularity that facilitates overall effectiveness and simple operation of the ligature/tie-wing ligation system by the operator.

Generally, with a facial or lingual bracket system, it is also common to use a tube attachment on molar teeth, rather than an open-face-slot bracket design. The tube type of attachment receives the arch-wire component via threading of the wire through the mesial or distal ends of the tube. This type of attachment has the benefit of not requiring the protruding, bulky, irregularly shaped tie-wings that are required of an open-face design. However, their applications are limited to the posterior teeth due to the necessity of threading the wire through the mesial or distal ends. It would be an impractical endeavor to attempt threading an arch-shaped wire through an entire dental arch starting from the most distal molar. Not only would the wire, at first, need to extend into the patients throat but the lack of a continuously consistent degree of curvature of the wire segment would preclude insertion of a wire of significant stiffness. In addition, the closed-face tube attachment precludes the placement of significant arch-wire bends, therefore, it is only practical if the attachment system is positioned with high precision and coordination.

As such, conventional bracket systems are designed to accommodate one bracket per tooth on either the facial or lingual side, but, as a practical matter, not both. They use open-face slots on anterior and most premolar teeth with tube attachments on the molar teeth. Note that many tube attachments designed for molars are also designed with a removable facial wall that allows the tube to be converted into an open-face bracket. Such designs also require the presence of tie-wings to hold the wire in place once the tube is converted to an open-face bracket.

The relatively large flat base characteristic of most conventional brackets serves several purposes. First, the relatively flat base is intended to rest against each tooth parallel to a tangent plane at the center of its mid-facial surface. This allows the operator the opportunity to use the surface of the tooth as a means of reference for establishing the properly coordinated position of each bracket—the operator simply must fully seat the bracket segment against the tooth at its mid-facial surface. Doing so orients the slot at its recommended three-dimensional pre-programmed (pre-coordinated) position. Second, the base serves as the bonding interface for rigid attachment to the tooth. As such, the “tooth-side” of the base generally possesses mechanical retentive features (such as a mesh pad, particle micro-etched surface, laser-etched surface, etc.) that facilitates durable bonding to the tooth by facilitating mechanical interlocking between an adhesive and the bracket via penetration of the adhesive into the retentive features. Some brackets, depending on their material composition, may also possess a base that bonds chemically to an adhesive. The base is relatively flat and large to provide a sufficient surface area for creating a durable bond to the tooth.

But a base of any substantial length compromises the ability to custom-coordinate positioning of a bracket in particular ways. For example, if the operator desires to place the slot at an alternative facio-lingual angle, the base interferes and creates an undesirable lever arm that necessitates displacement of the slot in an unfavorable way, a greater distance from the tooth surface. As such, to achieve coordination of the remaining bracket slots would require positioning them with an equal degree of offset away from the tooth surface. Moreover, with the bracket now positioned farther from the tooth, that is, creating a higher, more protruding profile, the bracket is more prominent and protruding so as to physically annoy a patient. And even when the bracket can be positioned with the base flat against the tooth, the width of conventional brackets alone makes them comparably protrusive, when most patients would prefer them to be minimally protrusive.

In addition, because lingual side tooth anatomy is more highly variable among individual tooth types compared with facial side anatomy, using a “base-dependent” positioning system to achieve a “straight-wire” result is even more impractical than the traditional facial bracket system. That is, a “fixed bracket shape with a base” designed for the lingual tooth surface is remarkably less effective at achieving coordination of slot positions such that a straight wire could then deflect the teeth to the desired positions. Because of this ineffectiveness, greater effort and greater unpredictability are realized by the operator who attempts to bend arch-wire to compensate for poorly coordinated lingual bracket slots.

If an operator desires the efficiency of a straight wire mechanical system to be used on the lingual side of teeth, this requires the ability to customize slot position for each patient. While this can theoretically be accomplished using a traditional bracket with a base and protruding tie-wings, the degree of protrusion and irregularity of shape (roughness) creates substantial discomfort for the patient. For this reason and others, lingual bracket systems have seen only very limited applications in orthodontics.

In addition, the desirability of adjustability has led to the predominant use of open-faced slots. In fact, open-faced slots are a practical necessity because of the obvious problem that a wire possessing compensating bends of significant size cannot be threaded through tubes of small cross-section and the obvious problems with insertion of full-length arch-wires through a closed-face bracket system. But with open-faced slots, the arch-wires must be secured, which is conventionally done by using ligature tie-wings. And the tie-wings create a relatively bulky, high profile bracket system and generally result in a highly irregular surface against which lips, cheeks, and tongue will rub and create discomfort.

Because of the cost associated with the vast inventory of brackets required, most operators use a manufacturer-specified shape (not a shape customized to the unique dental anatomy of the patient) for each tooth. Existing brackets do not allow for minimizing the profile and protuberances, which would create a far more comfortable lingual bracket system. The necessity of having tie-wings to engage ligature ties for the purpose of holding the wire engaged in the slot means that uncomfortably large, irregular protuberances are unavoidable.

U.S. Pat. Nos. 8,251,699 and 8,454,359, the entire disclosures of which are expressly hereby incorporated herein, disclose significant improvements over the above described brackets that provided significant advancement for lower profile and smoother contoured brackets that can be positioned on the lingual side of the teeth without compromising patient comfort and are less visibly noticeable, and can be positioned with great precision and flexibility. However, the present disclosure describes systems and methods that represent a further advancement of orthodontic brackets relevant to both lingual and facial applications.

### SUMMARY OF THE DISCLOSURE

An aspect of the present disclosure is to provide an orthodontic appliance that includes an indirect bonding tray; at least one bracket segment integrally formed with the indirect boding tray; an integral slot location feature formed in the at least one bracket segment; a support structure configured to be bonded with the at least one bracket segment and wherein the integral slot location feature is configured to positively orient the support structure relative to the at least one bracket segment, the support structure being further configured to retain an arch-wire; and wherein a weakened section joins the indirect bonding tray and the at least one bracket segment, the weakened section being configured to facilitate removal of the indirect bonding tray from the at least bracket segment after installation of the at least one bracket segment.

Another aspect of the present disclosure is to provide an orthodontic appliance including an indirect bonding tray integrally formed with one or more bracket segments, wherein each bracket segment is formed with an integral slot location feature to positively orient a support structure that is bonded with the bracket segment prior to installation of the appliance, wherein an arch-wire may be connected with the support structure prior to installation of the appliance, and wherein each bracket segment may be separated from a remainder of the indirect bonding tray after installation of the bracket segments with the arch-wire in place.

Yet another aspect of the present disclosure is to provide an orthodontic appliance that includes an indirect bonding tray integrally formed with one or more bracket segments; wherein each bracket segment is formed with an arch-wire engagement surface to positively engage an arch-wire; and wherein each bracket segment is configured to be separable from a remainder of the indirect bonding tray after installation of the bracket segments.

In another aspect of the present disclosure, an adhesive agent is employed to secure the support structure to the bracket segment, if applicable, and secure the bracket segment to a tooth surface.

In other aspects of the present disclosure, suitable methods for creating and installing an orthodontic appliance using embodiments of the device described herein are provided.

These aspects are merely illustrative of the innumerable aspects associated with the present disclosure and should not be deemed as limiting in any manner. These and other aspects, features and advantages of the present disclosure will become apparent from the following detailed description when taken in conjunction with the referenced drawings.

### DESCRIPTION OF DRAWINGS

Reference is now made more particularly to the drawings, which illustrate the best presently known mode of carrying out embodiments of the present disclosure and wherein similar reference characters indicate the same parts throughout the views.

FIG. 1 is a cross-sectional view of an embodiment of the present disclosure including an indirect bonding tray integrally formed with a bracket.

FIG. 2 is a perspective view of a completed orthodontic appliance including an indirect bonding tray, brackets, and arch wire according to another embodiment of the present disclosure.

FIG. 3 is a perspective view of a series of brackets and an arch-wire as installed in accordance with another embodiment of the present disclosure.

FIG. 4 is a cross-sectional view of another embodiment configured to accommodate multiple arch-wires.

FIG. 5 is a cross-sectional view of another embodiment including an arch-wire engagement surface.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the apparatus and systems of this technology and, unless explicitly stated otherwise, are not intended to be a representation that given embodiments of this technology have, or have not, been made or tested.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

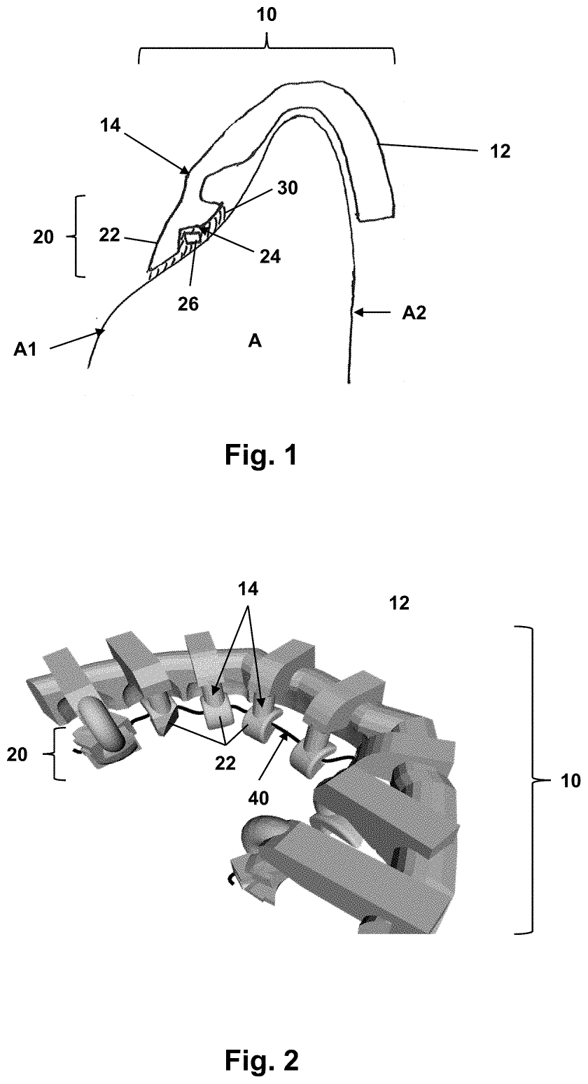

In comparison to prior appliances and methods of manufacture and application, the present disclosure provides for an orthodontic appliance 10 that is significantly easier to produce and install and is more comfortable to the patient. Embodiments of the present disclosure utilize an indirect bonding tray (“IBT”) 12 that may preferably be, at least in part, 3D printed based on a digital model of a patient's teeth A. Rather than serve simply as a carrier and/or positioning aid for a bracket that is separately formed, the arrangement of the IBT 12 may incorporate at least one bracket segment 22, into its structure. In other words, the bracket segment 22 itself may be formed by 3D printing with the rest of the IBT structure 12 as shown in FIGS. 1 and 2. Rather than simply serving as a mechanism for delivering brackets to a patient's teeth, the combined IBT 12 and bracket segments 22 can also accept a wire 40 component to form a completed orthodontic tooth moving system outside the mouth (in the lab). This whole system can be applied to a patient's teeth in a quick and simple bonding procedure without the need for additional wire insertion procedures.

The IBT 12 as presented here allows for the possibility of a fully 3D printed appliance and bonding tray combination (integration) which is easy and cost efficient to manufacture. There is no need for separate and independently manufactured brackets. The brackets 20 do not have to be separately, and by hand, manually, and individually installed inside of a separately manufactured IBT. The IBT 12 and bracket segments 22 may be 3D printed or molded with a single material or with multiple materials. For example, it may be desirable to utilize one material for the IBT 12 but another material for the bracket segments 22.

In addition, the special design of the appliance 10 presented herein provides both easy access for wire insertion and structural support to resist the forces applied by a pre-installed wire 40. Along with the special design of the “closed tube style” brackets 20, which do not require additional ligatures to hold a wire, this provides the option of installing the wire component 40 prior to bonding the brackets to the patient's teeth. In contrast, ligating a wire to a backet inside an IBT is nearly impossible with conventional designs. Therefore, embodiments of the present disclosure provide significant advantages in that (a) it allows for delegation of this procedure outside the doctor's office to a lab technician, (b) it is much easier to work outside the mouth, to see/visualize and access small tight areas with instruments, (c) patient appointments are much shorter, simpler and more comfortable, and (d) it results in increased office productivity and profitability by eliminating in-office procedures.

Significantly, at least in embodiments in which the bracket segment 22 is formed with the IBT 12, the bracket segment 22 may provide for registered orientation of a support structure 26, which may be, for example, a metal tube, through which an arch-wire 40 may be threaded. As can be seen in FIG. 1, the bracket segment 22 may be provided with a slot location feature 24 in its tooth-facing surface to match a portion of a support structure 26. This slot location feature 24 of the bracket 20 may be readily formed to accommodate any shape of support structure 26, the shape of which may be related to the cross-sectional shape of the desired arch-wire 40. In an exemplary case in which a rectangular metal tube is used as the support structure 26, the bracket slot location feature 24 may be a right-angled indentation in the tooth facing surface of the bracket segment 22. The indentation would properly orient the support structure 24 in a desired position relative to the respective tooth surface. Notably, the slot location feature 24 may be configured to facilitate essentially any facio-lingual angle.

The incorporation of the support structure 26 provides an opportunity to provide a metal engagement surface for the arch-wire 40. The metal-to-metal surface interaction between the support structure 26 and the arch-wire 40 creates less friction than an interaction with plastic or ceramic. A metal support structure 26 allows for tighter dimensional tolerancing, for example, to 0.001 inches, which is tighter than what is typically possible with printed plastic components. The metal support structure 26 is also more wear resistant, thereby providing more dimensional stability over time. Further, a metal support structure 26 provides a visual contrast relative to the rest of the bracket segment 22, making it easier to visually locate the appropriate insertion point for an arch-wire 40.

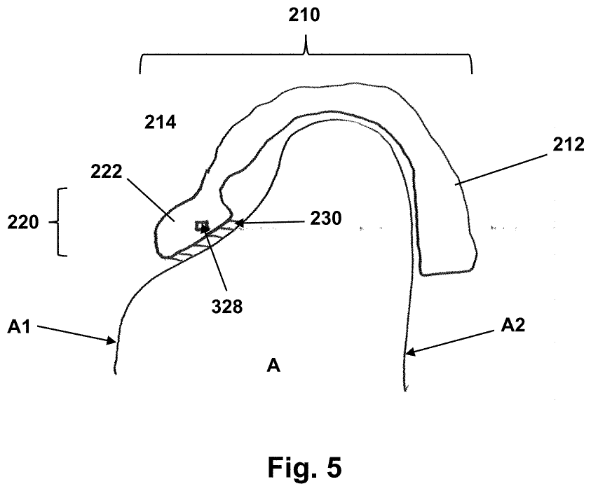

In alternate embodiments, such as shown in FIG. 5, the support structure may be replaced with an arch-wire engagement surface 228 that is molded directly into the bracket segment 222. In the illustrated example, the arch-wire engagement surface 228 is a cavity passing through the bracket segment 222 and has, in this case, a rectangular or square cross-sectional shape corresponding to the arch-wire to be installed. Such embodiments provide an appliance 210 with even fewer parts and, further, eliminates one more step in the construction/installation process for the appliance 210.

The flexibility of formation of the bracket slot location feature or arch-wire engagement surface in embodiments of the present disclosure may also facilitate including multiple slot location features 124 or arch-wire engagement surfaces in a bracket segment 122 in order to accommodate multiple support structures 126 or direct engagement with multiple arch-wires. Such an arrangement may be used for brackets 120 to be positioned at locations in an appliance 110 where there is a transition from one arch-wire to another (a tooth where two separate arch-wires must be accommodate and allowed to overlap), for example where the appliance 210 transitions from an anterior-wire-segment to a posterior-wire-segment. If suitable for any reason, embodiments of the present disclosure could include bracket segments having multiple slot location features or arch-wire engagement surfaces with each of those slot location features or arch-wire engagement surfaces being shaped to accommodate different forms of support structures and arch-wire configurations.

An adhesive agent 30 may be utilized in embodiments of the present disclosure. A non-limiting example of a suitable adhesive agent is light-cured dental composite resin. However, whereas in the systems of U.S. Pat. Nos. 8,251,699 and 8,454,359, the adhesive agent comprised as much as 99% of the bracket structure, it may comprise approximately 10% or even less of the bracket 20 structure in embodiments of the present disclosure. The adhesive agent 30 may serve as an adherent for the bracket 20 to the tooth surface in embodiments of the present disclosure. The adhesive agent 30 may also serve as the adherent for the support structure 26 to the slot location feature 24. The adhesive agent 30 may consequently form a small part of the tooth facing surface of the bracket 20.

As may be recognized by the foregoing description, the bracket 20 resulting from the apparatus and methods described in the present disclosure may be comprised slightly differently in various embodiments of the present disclosure. For example, the bracket 20 may include the bracket segment 22, which is the portion of the bracket 20 that is integrally formed with the IBT 12, by 3D printing as an example, the support structure 26, and the adhesive agent 30, which secures the support structure 26 to the bracket segment 22 and the bracket segment 22 to the tooth surface. In alternate embodiments, the bracket segment 222 may integrally incorporate an arch-wire engagement surface 228 for contact and retention of the arch-wire without need for a separate support structure. In such embodiments, an adhesive agent 230 may generally still be incorporated to secure the bracket segment 222 to the tooth surface.

During installation of the appliance, the IBT 12 may initially be positioned around the patient's teeth A. However, once the bracket segment(s) 22 integrally formed with the IBT 12 are bonded to the patient's teeth, the remaining portion of the IBT 12 is removed, thereby leaving only the bracket segments 22 in place. Separation of the rest of the IBT 12 from the bracket segment 22 portion of the IBT 12 post-installation may be facilitated by an intentionally weakened section 14 of the IBT 12 in some embodiments. For example, as shown in FIG. 1, a narrowed section may be provided in the IBT along a desired line of separation. In other embodiments, the intentionally weakened section 14 may be perforated.

Significantly, embodiments of the present disclosure may facilitate installation of the arch-wire 40 in the brackets 20 prior to the IBT 12 being applied to the patient's teeth. For example, an arch-wire 40, or multiple arch-wires if applicable, may be threaded through each of the support structures 26 of a completed IBT 12. This is facilitated, in part, because the support structures 26 may be registered and bonded within the slot location features 24 of the bracket segments 22 with no need for any type of positioning clip that would otherwise occlude the lumen of the support structure 26. In this manner, deliver of bracket segments 22 may combine the previously separate steps of (a) attaching the bracket segments 22 to the patient's teeth and (b) installing the arch-wire 40 in the bracket segments 22. This has not been possible with any previously known appliances. In combining these steps into a single process, the total time associated with installation of the appliance is dramatically reduced, thereby increasing efficiency for the orthodontist and staff and reducing patient discomfort during the installation process. This represents tremendous added value for both orthodontists and their patients. Embodiments in which an arch-wire engagement surface 228 is integrally incorporated into the bracket segment 222 would function similarly.

Further, embodiments of the present disclosure provide a means for readily creating fully customized brackets for either the lingual A1 or facial A2 tooth surface using digital tools and as a seamless part of the IBT formation. Because the bracket segment 22 is formed as a portion of the IBT 12, which, again, may be 3D printed, this provides the option of creating a fully customized appliance system with the unlimited potential for shaping the bracket segment 22 and the option for unrestricted fully customized orientation of the slot location features 24 or arch-wire engagement surfaces 228 of the bracket segments 22/222, while also decreasing (minimizing) the cost of producing such a highly customized bracket system by other means.

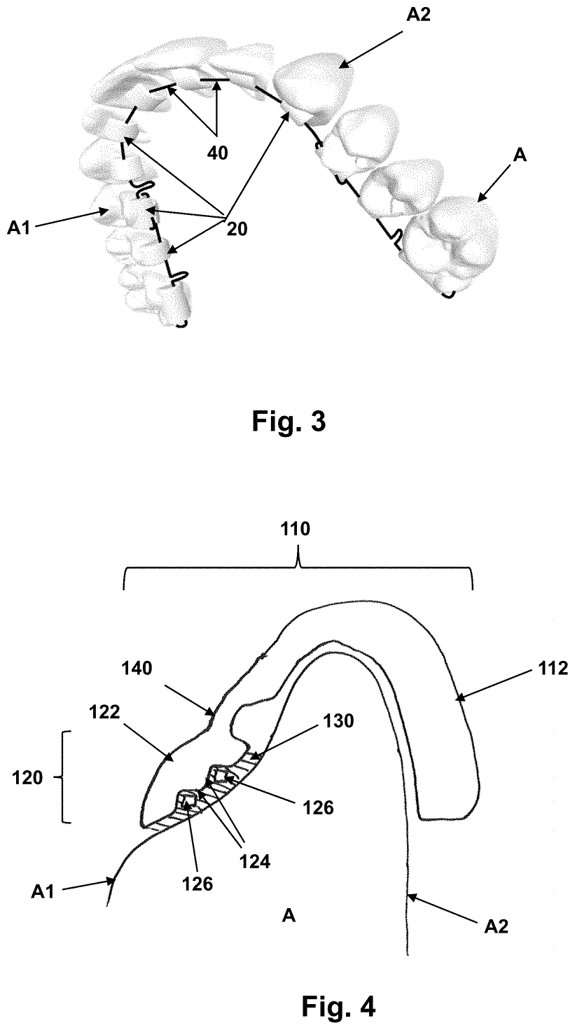

As can also be seen in FIG. 3, the bracket segment 22 may be formed with an extremely low profile, and with a completely smooth surface as a result of not needing tie-wings for wire retention, in applicable embodiments, with the result that the finished bracket 20 is provided with an extremely small form-factor. Thus, the bracket 20 may be provided with a significantly lower profile than previously possible.

Because of the extremely low profile, smooth surfaces and esthetically pleasing appearance (being optionally hidden on the tongue side) of embodiments of the present disclosure, these appliances may even be left in the patient's mouth as a replacement for a retainer that may otherwise be recommended after prior art appliances would be removed or for even longer periods of time as a long-term maintenance device. This is made possible because of the minimally obtrusive nature of the brackets 20 that renders them largely unnoticeable to the patient.

While the formation of embodiments of the IBT 12, including the bracket segments 22 and slot location features 24 or arch-wire engagement surfaces 228, herein has been presented in the context of using 3D printing, it should be appreciated that other manufacturing methods, including more traditional methods such as molding or milling, may also be used.

The preferred embodiments of the invention have been described above to explain the principles of the invention and its practical application to thereby enable others skilled in the art to utilize the invention. However, as various modifications could be made in the constructions and methods herein described and illustrated without departing from the scope of the invention, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

What is claimed is:

1. An orthodontic appliance, comprising:
an indirect bonding tray;
at least one bracket segment integrally formed with the indirect boding tray;
an integral slot location feature formed in the at least one bracket segment;
a support structure configured to be bonded with the at least one bracket segment and wherein the integral slot location feature is configured to positively orient the support structure relative to the at least one bracket segment, the support structure being further configured to retain an arch-wire; and
wherein a weakened section joins the indirect bonding tray and the at least one bracket segment, the weakened section being configured to facilitate removal of the indirect bonding tray from the at least bracket segment after installation of the at least one bracket segment.

2. The orthodontic appliance as set forth in claim 1, further comprising an adhesive agent configured to secure the support structure with the at least one bracket segment and the at least one bracket segment to a tooth surface.

3. The orthodontic appliance as set forth in claim 1, wherein the weakened section comprises a narrowed section of material provided with a smaller cross-sectional area relative to the indirect bonding tray.

4. The orthodontic appliance as set forth in claim 1, wherein the weakened section comprises a perforated section of material.

5. The orthodontic appliance as set forth in claim 1, wherein the at least one bracket segment is provided with at least a lingual surface and a tooth-facing surface and wherein the integral slot location feature is provided on the tooth-facing surface.

6. The orthodontic appliance as set forth in claim 1, wherein the at least one bracket segment is provided with at least a lingual surface and a tooth-facing surface and wherein the integral slot location feature is provided on the lingual surface.

7. The orthodontic appliance as set forth in claim 1, wherein the support structure comprises a tube configured with a cross-sectional shape corresponding to a cross-sectional shape of an arch-wire inserted through the support structure.

8. The orthodontic appliance as set forth in claim 7, wherein the support structure comprises a rectangular tube.

9. The orthodontic appliance as set forth in claim 7, wherein the support structure comprises a metallic tube.

10. The orthodontic appliance as set forth in claim 2, wherein the adhesive agent is a flowable light cured resin.

11. The orthodontic appliance as set forth in claim 2, wherein the at least one bracket segment, integral slot location feature, support structure, and adhesive agent form a bracket and wherein the adhesive agent comprises no more than approximately 10% of a mass of the bracket.

12. The orthodontic appliance as set forth in claim 1, further comprising a second integral slot location feature and a second support structure and wherein the second integral slot location feature is configured to positively orient the second support structure relative to the bracket segment.

13. The orthodontic appliance as set forth in claim 1, wherein the support structure and the integral slot location feature are formed by an arch-wire engagement surface in the bracket segment and wherein the arch-wire engagement surface is configured to positively engage and orient an arch-wire.

14. An orthodontic appliance, comprising:
an indirect bonding tray;
at least one bracket segment wherein the at least one bracket segment is integrally formed with the indirect boding tray;
an integral slot location feature formed in the at least one bracket segment;
wherein said integral slot location feature comprises an arch-wire engagement surface formed in the at least one bracket segment and wherein the arch-wire engagement surface forms a support structure configured to retain an arch-wire; and
wherein a weakened section joins the indirect bonding tray and the at least one bracket segment, the weakened section being configured to facilitate removal of the indirect bonding tray from the at least bracket segment after installation of the at least one bracket segment.

15. A method of forming and applying the orthodontic appliance as set forth in claim 1, comprising the steps of:
creating a mold of at least one tooth of a patient;
forming the indirect bonding tray, at least one bracket segment, and integral slot location feature based on the mold;
installing the support structure with the integral slot location feature;
installing an arch-wire with the support structure;
adhering the at least one bracket segment to the patient's tooth; and
separating the indirect bonding tray from the at least one bracket segment at the weakened section.

16. The method of forming and applying the orthodontic appliance as set forth in claim 15, wherein the step of forming the indirect bonding tray, at least one bracket segment, and integral slot location feature comprises 3D printing.

17. The method of creating and installing the orthodontic appliance as set forth in claim 15, wherein the step of forming the indirect bonding tray, at least one bracket segment, and integral slot location feature comprises molding.

18. The method of creating an installing the orthodontic appliance as set forth in claim 15, wherein the support structure is a tube and wherein the step of installing the arch-wire comprises inserting the arch-wire through the tube.
